(19) United States
(12) Patent Application Publication
(10) Pub. No.: US 2019/0300127 A1
(43) Pub. Date: Oct. 3, 2019

(54) WaveAnchor and WavePower, and methods of installation and use

(71) Applicant: David J. Hildebrandt, Woodside, CA (US)

(72) Inventor: David J. Hildebrandt, Woodside, CA (US)

(21) Appl. No.: 15/998,240

(22) Filed: Mar. 29, 2018

(51) Int. Cl. B63B 21/48; F03B 13/14

(52) U.S. Cl. CPC B63B 21/48; F03B 13/14

(57) ABSTRACT

A WaveAnchor and method of installing the WaveAnchor to stabilize the wave-induced rocking action of a boat, vessel or other floating platforms is provided. The present invention includes a method of creating downward pull on the WaveAnchor cables, which serves to stabilize a rocking boat or vessel, and further for harvesting the force of this downward pull for purposes of electrical generation by attaching the rope or cable from the WaveAnchor described above to a rotating shaft on the floating platform. Critical to this invention is the deployment of many such WaveAnchor devices around the edges of the floating platform, each of which transfers power to the central shaft. The power generation achieved by the WavePower platform with its deployed WaveAnchors is enhanced by the use of a floating platform which is not stable as it naturally rocks with wave action.

### CROSS REFERENCES TO RELATED PATENT APPLICATIONS

The difficulties in providing stability to the rolling and pitching of floating platforms, boats and the like are well established. Many inventions have been tried over the years, and all of them share the disadvantages of complexity of construction, inconsistency of operation, and lack of flexible strength to react to the pressures of wave actions. In addition, none of them document the provision whereby the forces generated by resistance to wave action are captured and conveyed for use with power generation.

As examples of some known boat stabilizers, one may refer to any of the following United States patents.

U.S. Pat. No. 1,299,186 to T. Imaizumi a ship stabilizer which includes a plurality of upright cups suspended from opposite sides of a boat.
U.S. Pat. No. 3,179,078 to J. R. Popkin is directed to a hydrofoil stabilizer for sailboats.
U.S. Pat. No. 2,561,539 to Seaward is directed to a marine stabilizer which includes a triangularly shaped fin, which is weighted at its forward extremity by means of a weight. The fin is attached to a pole projecting transversely from a boat by means of a cable. When the boat rolls to one side the weight will cause the fin to plunge downwardly nose first and when the boat rolls to the opposite side, raising the fin, the cable will pull the nose of such fin upwardly causing such fin to assume a horizontal orientation to resist rolling of the boat.
U.S. Pat. No. 3,260,232 to D. W. Douglas discloses a stabilizer suspended from a boat by means of a pair of cables positioned forwardly and rearwardly of the center of gravity of such stabilizer whereby the pitch thereof may be controlled.
U.S. Pat. No. 3,589,324 which is known in the industry as Roll-Control and consist of a rectangular frame structure covered by a sheet material that is cut in the center thereof to define a flap valve.

Other known stabilizing devices include the ROLL-EEZ which is a rectangular frame member having a plurality of movable vanes mounted therein and the Rocker-Stopper which is a cone-shaped device formed from a lightweight plastic.

Additional patents describing similar devices and inventions include:

U.S. Pat. No. 6,684,808 Callahan Feb. 3, 2004 A device for providing stability and directional control to a boat.
U.S. Pat. No. 6,135,046 Beech Oct. 24, 2000 A sea anchor having a leading edge that is outfitted with a flexible, resilient hoop member that biases the leading edge to self-expand.
U.S. Pat. No. 5,394,817 Kaufman Mar. 7, 1995 A sea anchor or boat drag apparatus formed from a cylindrical tubular body and designed for inflated deployment from a fishing boat or the like and arranged to provide controllable or selectable drag forces ranging from zero drag force to a substantial drag force.
U.S. Pat. No. 5,419,275 Wood May 30, 1995 A sea anchor or boat drag apparatus formed from a cylindrical tubular body and designed for inflated deployment from a fishing boat or the like and arranged to provide controllable or selectable drag forces ranging from zero drag force to a substantial drag force.
U.S. Pat. No. 5,241,922 Allen Sep. 7, 1993 The invented sea anchor is made from two sheets of flexible material sewn together to create a generally frustum-shaped body.
U.S. Pat. No. 5,095,839 Peterson Mar. 17, 1992 An apparatus for stabilizing a vessel to drastically reduce the rolling and/or pitching of floating vessels, platforms, or the like.
RE33,068 Abernethy Sep. 26, 1989 A device of the nature of a sea-anchor has a body tapered to the nose where it is attachable to a cable from a boat and formed with ports normally closed by spring-loaded closures but opened, by predetermined cable tension, to increase resistance to passage through water.
U.S. Pat. No. 4,612,870 Shewmon Sep. 23, 1986 Structures and methods for constructing sea anchors having body portions defined by at least three spaced corners or vertices wherein bail ropes are sewn to and extend diagonally inwardly from each corner toward the center of the body portion so that stresses applied to the stitching are distributed and absorbed by stretching the material along its diagonal lines.
U.S. Pat. No. 4,562,788 Abernethy Jan. 7, 1986 A device of the nature of a sea-anchor has a body tapered to the nose where it is attachable to a cable from a boat and formed with ports normally closed by spring-loaded closures but opened, by predetermined cable tension, to increase resistance to passage through water.
U.S. Pat. No. 4,534,306 Rutten, et al. Aug. 13, 1985 A tandem array of sea anchors is provided.
U.S. Pat. No. 4,061,102 Bissett Dec. 6, 1977 A stabilizer device for minimizing the roll of a boat including two plates connected by a hinge and a plurality of bridles attached to the plates so that when the stabilizer is pulled up through the water by the bridles the plates open about the hinge to resist upward motion and when the stabilizer is released the plates close together about the hinge to permit the stabilizer to fall rapidly.

References cited regarding wave power generation, United States Patent documents.

U.S. Pat. No. 1,018,678 February 1912 Nelson
U.S. Pat. No. 1,061,091 May 1913 Lewis
U.S. Pat. No. 4,077,213 March 1978 Hagen

### RE31111 December 1982 Hagen

U.S. Pat. No. 4,400,940 August 1983 Watabe
U.S. Pat. No. 4,408,454 October 1983 Hagen
U.S. Pat. No. 4,490,621 December 1984 Watabe
U.S. Pat. No. 4,580,40 April 1986 Watabe
U.S. Pat. No. 4,684,815 August 1987 Gargos
U.S. Pat. No. 4,781,23 Nov. 1988 Gordon
U.S. Pat. No. 5,132,550 July 1992 McCabe
U.S. Pat. No. 8,004,15 Aug. 2011 Whittaker
U.S. Pat. No. 8,686,582 April 2014 Gardiner
U.S. Pat. No. 9,115,689 August 2015 Malligere

### 2008/0018114 January 2008 Weldon

### 2010/0038913 February 2010 Svelund

### 2011/0042954 February 2011 Werjefelt

### 2011/0057448 March 2011 Page

### 2012/0153627 June 2012 Jo

### 201410230426 August 2014 Tuokkola

### 2014/0248151 September 2014 Dong

U.S. Pat. No. 9,902,467 Feb. 27, 2018 Lin, et al. Wave power generation device and method for operating and maintaining the same

### FEDERALLY SPONSORED RESEARCH OR DEVELOPMENT

Not applicable. No federal sponsorship was used in the research or development of this invention.

### NAMES OF PARTIES IN JOINT RESEARCH AGREEMENT

Not applicable. No other parties were engaged in research or development related to this invention.

### REFERENCE TO “SEQUENCE LISTING”

Not applicable

### BACKGROUND OF THE INVENTION

The invention (“WaveAnchor”) was initially designed to stabilize a boat against the rocking motion of waves on large bodies of water such as lakes, bays, or oceans. The invention was further refined to include the utility provided by transmitting the push/pull energy captured by the WaveAnchor for the purpose of power generation using WavePower.

### SUMMARY OF THE INVENTION

The WaveAnchor is comprised of a tapered cylinder of canvas, nylon or similar material which is open at the top and larger end, and closed by hinged baffles at the bottom and smaller end. The lower end is weighted to ensure that the WaveAnchor is pulled down during the downward motion of wave action. During this downward motion, the baffles at the bottom end of the tapered cylinder hinge upward allowing water to flow freely into the tapered cylinder. Combined with the effect of the weight, the tapered cylinder moves freely down through the water with the pull of gravity. When the wave action shifts to an upward direction, the hinged baffles quickly close due to water pressure from the upward motion. This closed, tapered cylinder then creates significant drag through the water during this upward wave motion. At the top of the upward wave action, the tapered cylinder reverses direction downward and once again gravity pulls the cylinder down, opening the hinged baffles and moving freely downward again,

The described WaveAnchor is tied securely to a boat or other floating platform. During the upward and downward motion cycles described above, the effect of the tapered cylinder is to provide resistance to upward movement but to move freely through the water with gravity during the downward motion. With a WaveAnchor tied to each side of a boat which is rocking in response to undulating waves, the effect is to stabilize the boat by imparting resistive force to each side of the boat only as it moves in the upward direction. Installing four WaveAnchor devices on a boat, two on opposite sides at the bow or front and two more on opposite sides in the rear or stern of the boat, provides resistive forces against all directions of wave-driven rocking, front to back and side to side.

For the purposes of power generation (“Wave Power”), a system of 2, 3, 4 or more WaveAnchors are deployed on a large, heavy floating platform. The platform, which will normally roll and pitch with wave action, is stabilized by the deployed WaveAnchors. Each WaveAnchor provides a pull force when the platform is moving upward at the point of WaveAnchor deployment. The cable to which each of the WaveAnchors is attached is used to convey this pull force to a rotational gear mechanism mounted on a central shaft, standard to the industry. Each of the WaveAnchors deployed on the floating platform in turn provides pull force to its related cable as that portion of the platform is rolling in an upward motion. The rotational gear is one-directional, in that it only imparts force from the WaveAnchor cable to the central power shaft of the turbine power generator when the cable is creating a pull force. When not pulling, the rotational gear is spring loaded and rotates back to a home position.

### DESCRIPTION OF THE SEVERAL VIEWS OF THE DRAWINGS

WaveAnchor Design

FIG. 1 shows the overall WaveAnchor tapered cylinder device. The line at the top is tied to the cleat of a boat or other secure tying point on a floating raft or platform. Down from this top line and typically under the water mark are several securing lines which travel to and are firmly tied to the sides of the top end of the tapered cylinder (FIG. 2).

FIG. 2 shows a tapered cylinder, or fill bag, is-made of canvas, nylon or other similar material (FIG. 3). Sewn or otherwise secured into the upper end of this cylinder is the top, hinged hoop of metal (FIG. 7). The top securing lines described above are tied to this top, hinged metal loop. At the bottom of the tapered cylinder, or fill bag, is a smaller metal loop in this case not hinged but bolted closed and sewn or otherwise secured into the lower end of the cylinder. Also installed in this smaller, lower end of the tapered cylinder is the baffled lower opening and attached weight to pull the WaveAnchor down (FIG. 4). This is comprised of two cross bars which are secured to the lower end metal hoop, one at 90 degrees to the other and meeting in the middle (FIG. 5).

FIG. 3 shows the tapered fill bag with an example of dimensions and amount of taper.

FIG. 4 shows the baffled lower opening of the tapered cylinder or fill bag (side view). The baffles open with downward movement of the WaveAnchor, and close with upward movement. The attached weight pulls the WaveAnchor down and opens the baffles with downward movement. A retrieval rope is attached to the weight to allow easy removal of the WaveAnchor assembly from the water when not in use.

FIG. 5 shows the construction of the frame for the baffled bottom of the tapered cylinder or fill bag.

FIG. 6 further shows the construction of the baffled bottom flaps

FIG. 7 shows the hinged bars for the top opening of the tapered cylinder or fill bag. The two bars are each bent into a half circle and attached at their ends, allowing the two halves to fold for easier storage.

WavePower Design

FIG. 8 shows an example of a heavy, floating platform which is attached to multiple WaveAnchors around its circumference.

FIG. 9 displays how the WaveAnchor cables are attached to one-directional rotating gears on a central power generation shaft.

FIG. 10 illustrates how the floating platform is designed with a high center of gravity which amplifies its rocking motion. In the diagram shown, the high center of gravity is accomplished by adding a wind turbine to the top of the generator shaft. Power from the wind turbine blades is transferred to the power generator by standard methods in the industry.

FIG. 11 illustrates how the WaveAnchors are attached to a boat hull.

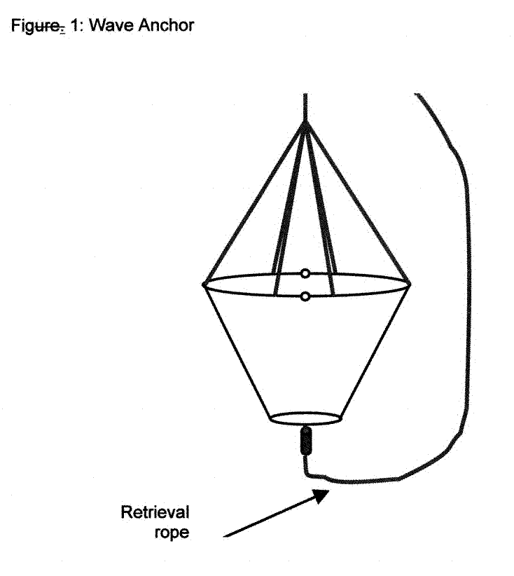

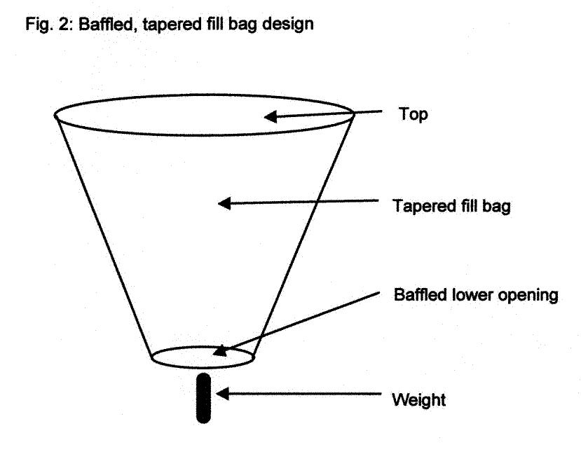

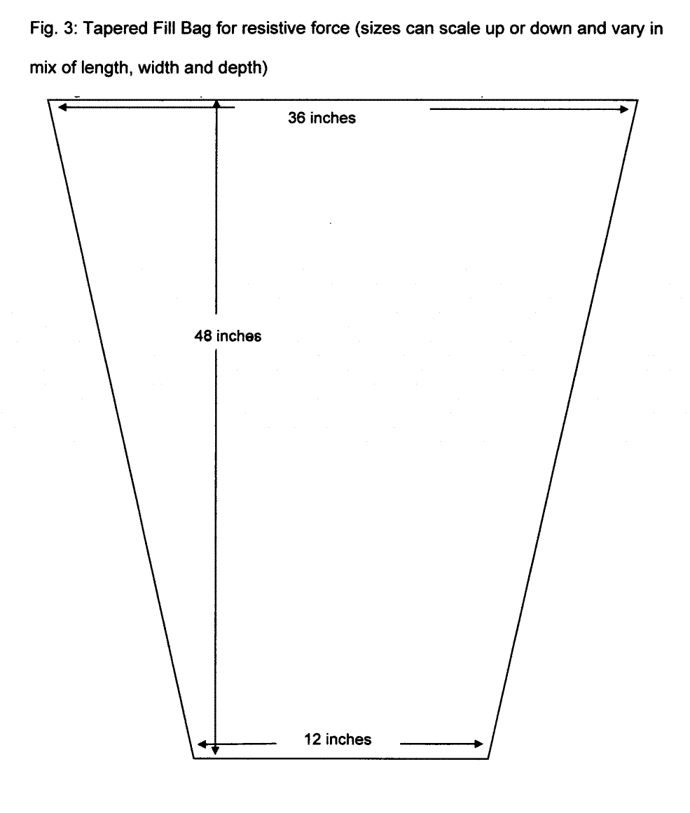

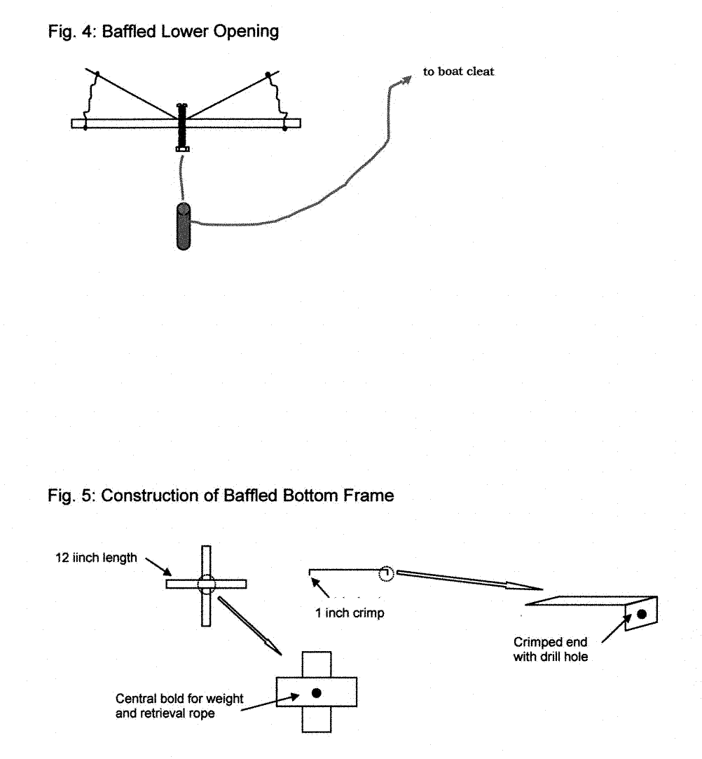

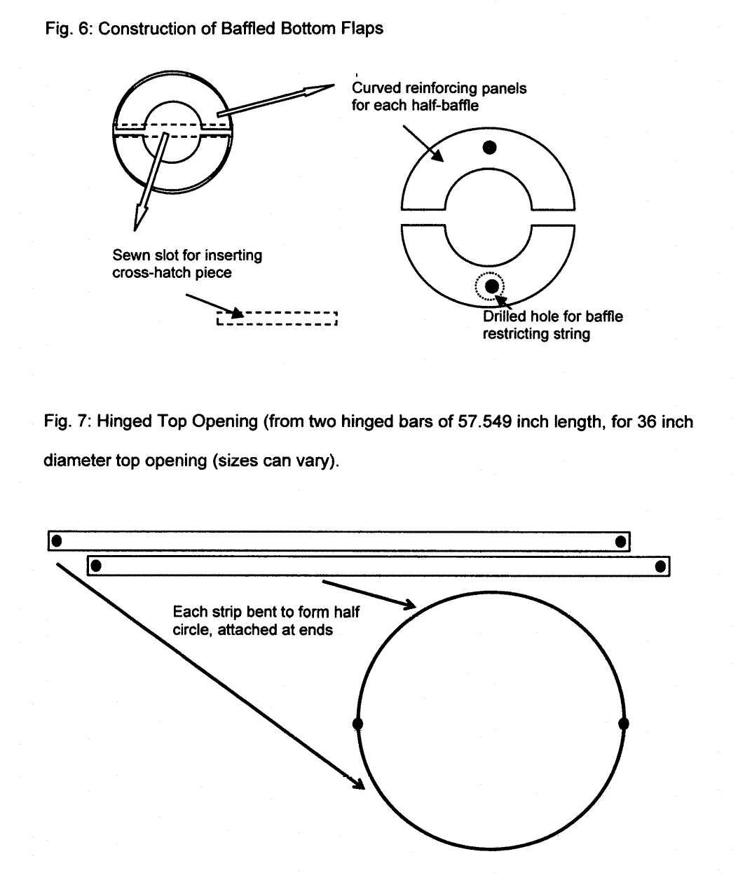

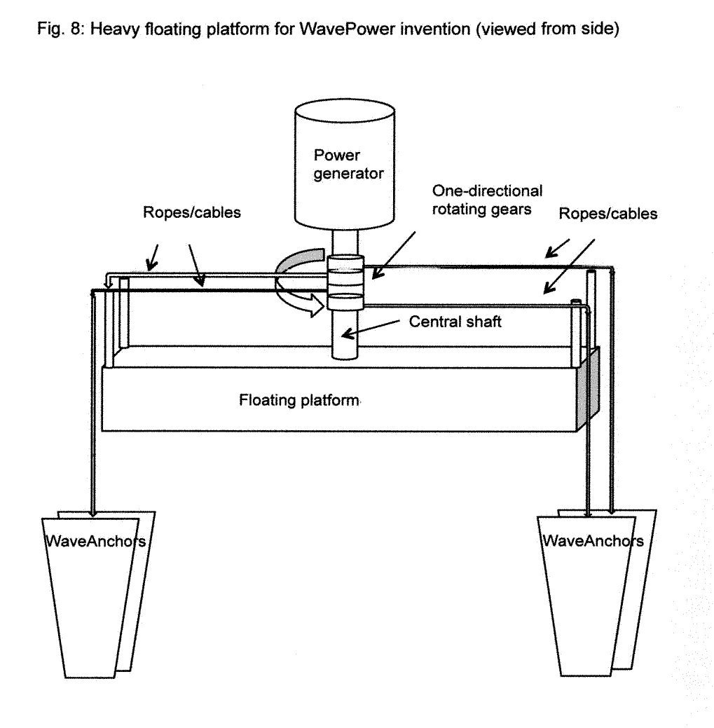

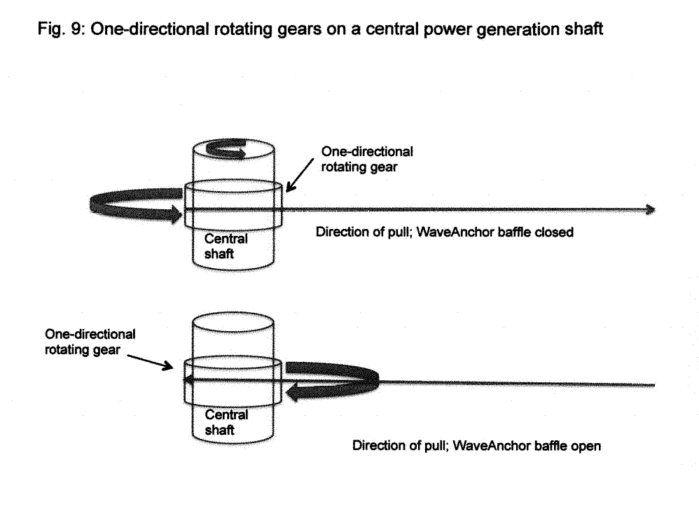

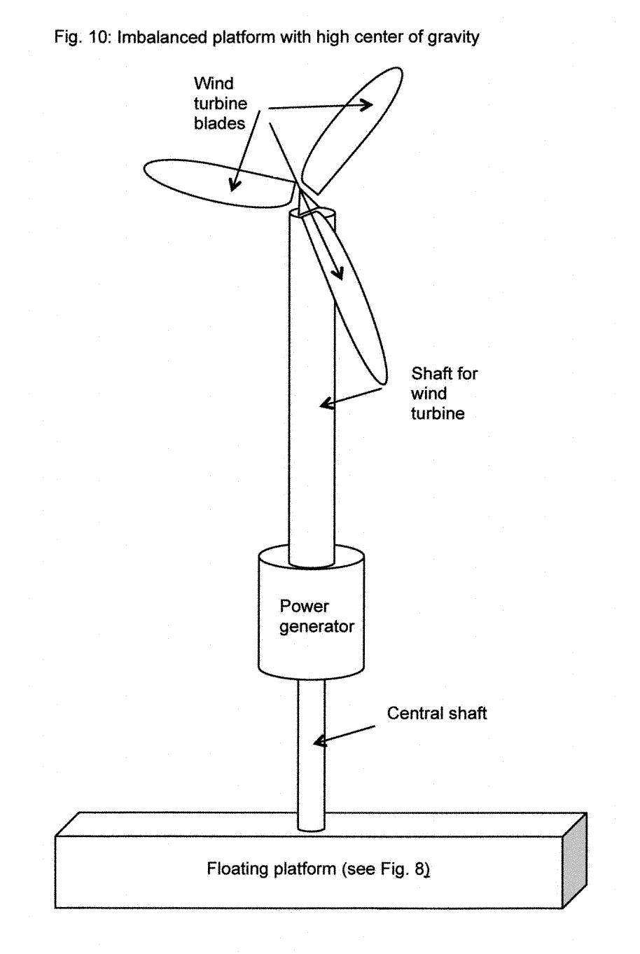

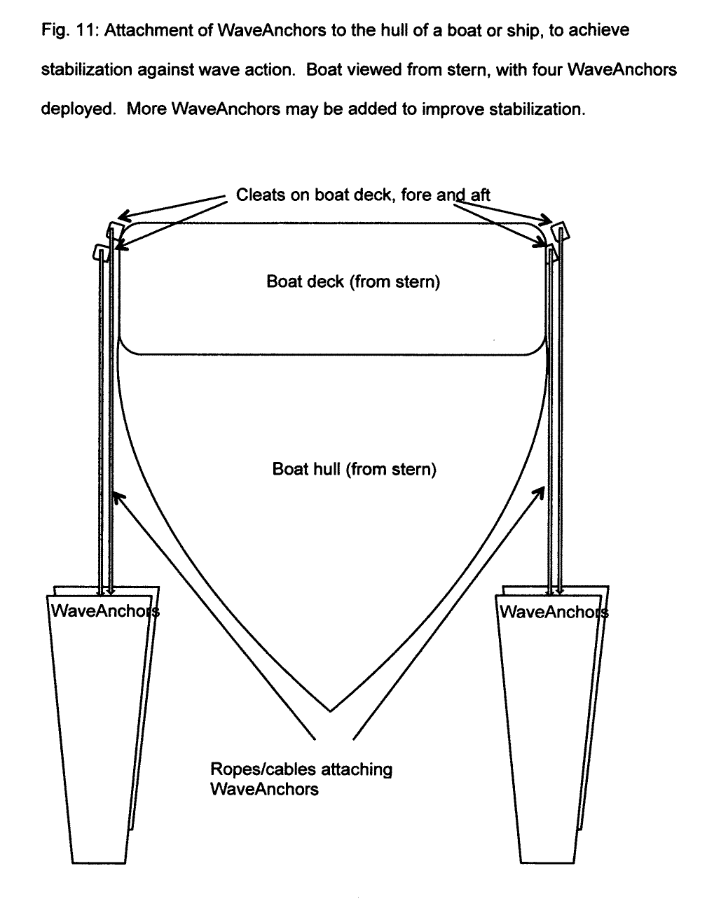

1. Baffled sea anchor, comprised of a large cylindrical bag which is larger at the top, open end and closed at the bottom, smaller end. The smaller end is closed with a baffled set of half-circle flaps which open when the sea anchor is moving in a downward direction, but are pushed closed when moving in an upward direction.

2. Generation of power by means of a rocking, imbalanced floating platform anchored with the described sea anchor(s), by connecting the ropes or cables from a number of sea anchors to a power generator mounted on a heavy floating platform. The platform can also be used to mount a wind turbine, standard to the industry, to supplement the generation of power.

3. A rotating, one-directional power generation gear which resets to a home position on spring loaded control and is mounted on a central power generation shaft. Multiple such gears can be used to collect pull power from each of the deployed sea anchors.
Many features have been listed with particular configurations, options, and embodiments. Any one or more of the features described may be added to or combined with any of the other embodiments or other standard devices to create alternate combinations and embodiments. Therefore, it is noted that various preferred embodiments of the present invention employ differing combinations of the optional and necessary components of the present invention.
Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.
